(19) United States
(12) Patent Application Publication
(10) Pub. No.: US 2010/0026187 A1
(43) Pub. Date: Feb. 4, 2010

(54) LUMINAIRE DRIVE CIRCUIT

(76) Inventors: William Kelly, County Cork (IE); John Bouchier, County Cavan (IE); Mark Walshe, Cork (IE); Desmond John O'Brien, County Cork (IE)

Correspondence Address: JACOBSON HOLMAN PLLC, 400 SEVENTH STREET N.W., SUITE 600, WASHINGTON, DC, 20004, US

(21) Appl. No.: 12/311,939

(22) PCT Filed: Oct. 18, 2007
(86) PCT No.: PCT/IE2007/000102

§ 371 Date: Sep. 23, 2009

(30) Foreign Application Priority Data
Oct. 19, 2006 (IE) 2006/0767
Jun. 26, 2007 (IE) 2007/0459

(51) Int. Cl. H05B 37/02

(52) U.S. Cl. 315/113; 315/185 R; 315/152

(57) ABSTRACT

A luminaire drive circuit (1) comprises an AC to DC power supply (2) delivering DC power to rails (3), and a plurality of LED drive circuits (4) connected across the rails to receive DC power. Each LED drive circuit (4) comprises a plurality of LEDs (7) in series and a voltage and current controller (6) for controlling current through the LEDs and a voltage across the LEDs which is less than the voltage across the rails. In one example, each LED circuit (4) has a dedicated sensor (52) to detect proximity of an illuminated object. This allows control of illumination intensity both for energy efficiency and visual effect. The proximity sensor may be simply a photodiode (52) mounted to detect extent of light reflected from the objects (FIG. 5), thus avoiding need for a self-contained proximity sensor such as one of the ultrasonic type.

### FIELD OF THE INVENTION

The invention relates to luminaires having light emitting diodes.

### FIELD OF THE INVENTION

When LEDs are used as luminaires, there are generally several key performance characteristics, including luminous flux, illumination uniformity, electrical efficiency, lifetime, colour rendering index (CRI), and colour temperature. The relative importance of these parameters depends on the function of the luminaire, however if the application is retail display, these key metrics are of near equal importance and the lighting system must be designed to target all six.

Luminous flux is a measure of the amount of light output by the source.

Illumination uniformity is important so the product on display is illuminated correctly and there are no excessively dark areas or bright areas.

With the extent of lighting in retail premises electrical efficiency is very important. A reason for using LEDs for retail display instead of traditional sources such as fluorescent tubes is the possibility for improved efficiency and hence lower energy costs.

The lifetime of a luminaire is important since the frequency at which it needs to be replaced greatly affects the overall cost of ownership.

CRI is a measure of the ability of a light source to reproduce the colours of the illuminated objects. The higher the CRI, the more realistic the lit object will look and the more pleasing it will appear to the eye. In retail environments there is a wide variety of colours of products on display.

Colour temperature is a way to characterize the spectral properties of a light source, expressed in Kelvin. A low value means warm, yellowish light whilst a high value means cool, bluish light. For an LED, the colour temperature is a characteristic of its manufacturing process and material make-up, however it does change with current.

Since the light output from an LED is essentially proportional to the current through it, normal practice is to control LED current in order to achieve the desired luminous flux. One common option for controlling LED-based luminaires is to drive chains of LEDs in parallel with a single current controlled power supply, mounted remotely from the luminaire. The total current to the luminaire is regulated and the assumption is that this current will divide evenly between the parallel chains. However, due to variations in forward voltage between individual LEDs the current will not always divide equally. In some cases, the difference may be great enough to cause a significant difference in brightness between the two chains and the lifetime of the LEDs in the chain carrying the greater current will be diminished. In addition, should a single LED fail it will cause the entire luminaire to fail thus:
(i) if the LED fails and creates an open circuit in the chain, the current in the other chain(s) will increase, and according to the particular circumstances and actual configuration of the LEDs the effects will range from somewhat diminished lifetime of the remaining LEDs to rapid and complete failure of the luminaire, and
(ii) if the LED fails and goes short circuit, the current in that chain will increase and may cause the other LEDs in the chain to fail in a chain reaction, and finally the luminaire will fail completely.

Furthermore, even if the difference in current between the parallel chains is not enough to cause reliability problems, the individual LED chains will produce light of slightly different colour temperature, and uniformity will be adversely affected.

Another known approach to controlling LED-based luminaires is to apply a fixed voltage to a chain of LEDs and to regulate the current using a linear regulator. The power in the luminaire will be the same irrespective of the LED forward voltages. A white LED may have a nominal forward voltage of 3.5V at its operating current, however this will vary from LED to LED, typically between 3.2V and 4V. Given that the linear regulator itself will typically require 2V to operate correctly, this means that for a 24V supply the maximum number of LEDs in a chain is five. Any excess voltage over that required by the LEDs will cause power to be dissipated as heat, and to serve no function in producing light. At the extremes of the LED voltage ranges, the maximum amount of the input power that is used in producing light is 83%, whereas the minimum is 66%. Furthermore the regulator chosen must be capable of dissipating 33% of all power in the circuit, which can lead to a large expensive component if using high power LEDs. This is clearly unsatisfactory from a power management point of view, with the circuit exhibiting poor and unpredictable efficiency in converting input power to light.

The invention is directed towards providing an improved luminaire drive circuit.

### SUMMARY OF THE INVENTION

According to the invention, there is provided a luminaire drive circuit comprising:
DC power rails, and
a plurality of LED drive circuits connected across the rails to receive DC power, each LED drive circuit comprising a plurality of LEDs in series and comprising a voltage and current controller for controlling current through the LEDs and voltage across the LEDs which is less than the voltage across the rails.

In one embodiment, a fixed voltage plus the total LED forward voltage is less than a worst case minimum supply voltage.

In one embodiment each LED drive circuit comprises a FET component in series with a supply rail to provide reverse polarity protection

In one embodiment the FET component is of p-type, the drain of the FET is connected to a positive rail input and the gate of the FET is connected to a negative rail input.

In one embodiment, the drive circuit further comprises a bridge for each LED circuit comprising four FETs arranged to ensure the circuit powers up irrespective of supply polarity.

In one embodiment the circuit is on a circuit board over a metal substrate, in turn over a metal heat sink.

In one embodiment there is a capacitor coupling the circuit to the metal substrate.

In one embodiment the capacitor has a value in the range of 0.001 uF to 10 uF.

In one embodiment the capacitor is connected to the top end of a screw fastener, said fastener extending through an insulating part of the circuit board and to the metal substrate.

In one embodiment the drive circuit further comprises an environmental sensor means, and each LED circuit voltage and current controller responds to a control signal input from said sensor means.

In one embodiment the control input is in a pulse width modulation (PWM) format.

In one embodiment said control signal input is connected to a global control line, and said control line is connected to said environmental sensor means.

In one embodiment the environmental sensor means comprises a proximity sensor for sensing proximity of an illuminated object, and at least one voltage and current controller automatically varies LED current and therefore illumination level according to object proximity.

In one embodiment the environmental sensor means comprises a temperature sensor, and at least one voltage and current controller automatically lowers LED power consumption in response to excessively high temperature of the drive circuit or an LED circuit.

In one embodiment the environmental sensor means comprises an ambient light sensor and at least one voltage and current controller automatically controls the level of illumination according to the ambient light level.

In one embodiment the environmental sensor means comprises a proximity sensor, a temperature sensor, and an ambient light sensor, and at least one voltage and current controller comprises means for controlling uniformity of illumination according to combination of illuminated object proximity, temperature, and ambient light.

In one embodiment the proximity sensor comprises a photodiode mounted to detect the extent of LED-emitted light which is reflected from a proximal illuminated object.

In one embodiment there is a dedicated environmental sensor for each LED circuit.

In another aspect, the invention provides any luminaire drive circuit as defined above, wherein each LED circuit is on a linear circuit board, and the circuit boards are electrically interconnected by connectors at each end of the board.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a circuit diagram of a luminaire drive circuit of the invention;

FIG. 2 is a diagram of a FET bridge of the circuit;

FIG. 3 is a cross-sectional diagram showing physical arrangement of the circuit components;

FIG. 4 is a diagram of an alternative luminaire drive circuit;

FIG. 5 is a diagram illustrating operation of a proximity detector; and

FIG. 6 is a diagram showing physical interconnection of circuit boards to provide a linear luminaire.

### DESCRIPTION OF THE EMBODIMENTS

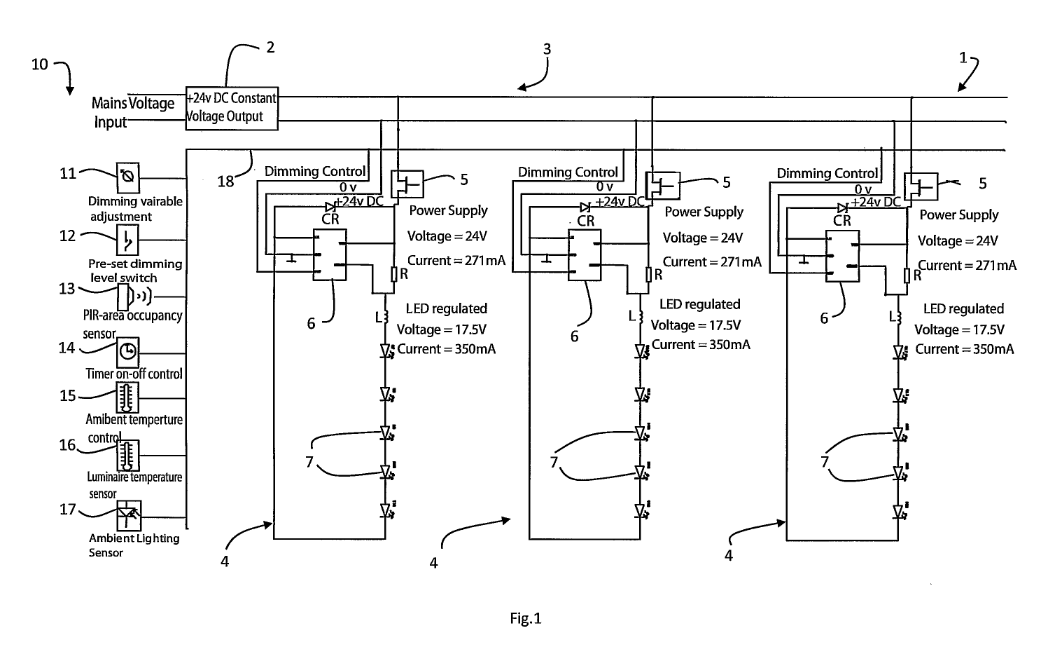

Referring to FIG. 1 a luminaire drive circuit 1 comprises a power supply 2 providing 24 V DC constant voltage across rails 3. The rails 3 provide 24V DC across a number, in this case three, LED circuits 4. Each LED circuit 4 comprises a p-type FET reverse polarity protection component 5, and a voltage and current controller 6 receiving 24 V DC and 271 mA from the rails 3. The regulator 6 in turn provides a regulated voltage of 17.5V DC across LEDs 7 and a current of 350 mA through them.

Thus, even if the rail 3 voltage level varies, the series 7 of LEDs receive the correct supply voltage of 17.5V. Also, if there is a short-circuit fault in an individual LED circuit 4 then that circuit does not draw a large current. This achieves excellent uniformity of light output across the LED circuits 4, and contributes to LED lifetime.

In more detail, the voltage and current controller 6 comprises a switch to enable current to flow from the positive supply through the LEDs to 0V, a current sensing circuit to continuously monitor the LED current, and a circuit to allow the current to be adjusted externally.

The reverse polarity protection component 5 comprises a p-type FET with its drain connected to the positive supply, its gate connected to the negative supply. This is an efficient reverse polarity protection scheme. The source of the FET then becomes the positive power rail. The typical resistance of a suitable FET is 25 mOhm, meaning for a 1 A current Vfet is 25 mV and the power loss in the protection circuitry is 0.025 W. This gives a twenty fold improvement in power losses due to reverse polarity protection, compared with conventional reverse protection diodes.

There is an inductor L in series with the LEDs 7. This has a value of 100 uH and is for supplying current to LEDs when the switch in the controller is open and there is no electrical path from the positive supply to 0V.

Taking a desired LED current of 350 mA, five LEDs 7 in the chain, and a DC voltage of 24V supplied. If the average voltage drop of the LEDs is 3.5V there is a total of 17.5 volts dropped across the LEDs. Therefore the power in the LEDs is 17.5×0.35=6.125 W. The efficiency of the current controller 6 is 94%, meaning that 0.39 W is lost as heat and the total circuit power is 6.5 W. Therefore the current supplied into the LED circuit 4 is 6.5 W/24V=271 mA. Should the supply voltage on the rails 3 vary from its nominal 24V the current supplied to the circuit will change such that the total circuit power (supply voltage times supply current) remains essentially the same at 6.5 W. This is considerably more efficient than a linear controller, which in the same scenario would consume 24V×0.35 A=8.4 W of power.

At start-up, the current controller closes a switch to 0V at its pin marked Lx. Current then starts to increase in the LEDs, with the rate of increase determined by the value of the inductor L and the supply voltage. When the current reaches a set level, set by the resistor R and measured across the resistor R by the controller, the switch is opened. Current continues through the LEDs, but now through the Schottky diode CR and back to the positive supply rail. This current is supplied by the energy stored in the inductor L. When the current reduces below a certain level, the switch is once again closed and the cycle repeats itself. The frequency at which this cycle repeats itself varies depending on various parameters (such as the value of the inductor, the LED current, the supply voltage and the LED forward voltages) but is generally in the region of hundreds of kilohertz. The high efficiency throughout the range of LED forward voltages is maintained because the switching of the current path to 0V is automatically adjusted according whatever conditions prevail.

In the table below, it is assumed that the LEDs 7 are white LEDs with a nominal forward voltage of 3.5V, minimum 3.2V, and maximum 4.0V. Also, circuit efficiency is defined as the ratio of the amount of power that is used to produce light divided by the total power delivered to the LED circuit 4. For comparison, the efficiency achieved by a linear controller carrying out the same task is also included.

TABLE 1
Actual circuit efficiency throughout Vf range

| LED forward | Circuit efficiency | Circuit efficiency |
|---|---|---|
| voltage Vf | (Luminaire Drive Circuit) | (using linear controller) |
| 3.2 V | 93% | 66% |
| 3.5 V | 94% | 73% |
| 4.0 V | 96% | 83% |

The following is a sample measurement of actual wallplug efficiency for the luminaire of the invention
LED power consumption: 67.2 W. 140 LEDs in 28 chains of 5 LEDs each (average Vf of 3.2V). LED current 150 mA.
Luminaire power consumption: 71.8 W
Luminaire electrical efficiency: 94%
Wallplug power: 79 W
External power supply efficiency: 92%
Total wallplug efficiency: 86.5%
Controlling the current in the LEDs 7 regulates the luminous output, CRI, and colour temperature and ensures that the LEDs 7 operate within their recommended specification, thus enhancing luminaire lifetime.

FIG. 1 also shows a bank of environment sensors and control devices 10. These are:
11, manual dimming adjustment knob;
12, pre-set dimming level switch;
13, occupancy sensor;
14, timer controller;
15, ambient temperature sensor;
16, luminaire temperature sensor; and
17, ambient lighting sensor.

Any of these devices can send a dimming control signal on a control line 18, connected to a control input of each current controller 6. This provides universal dimming control to all of the LED circuits 7 together, in response to any of a range of environmental conditions and user controls. This achieves very effective control, optimising electrical efficiency.

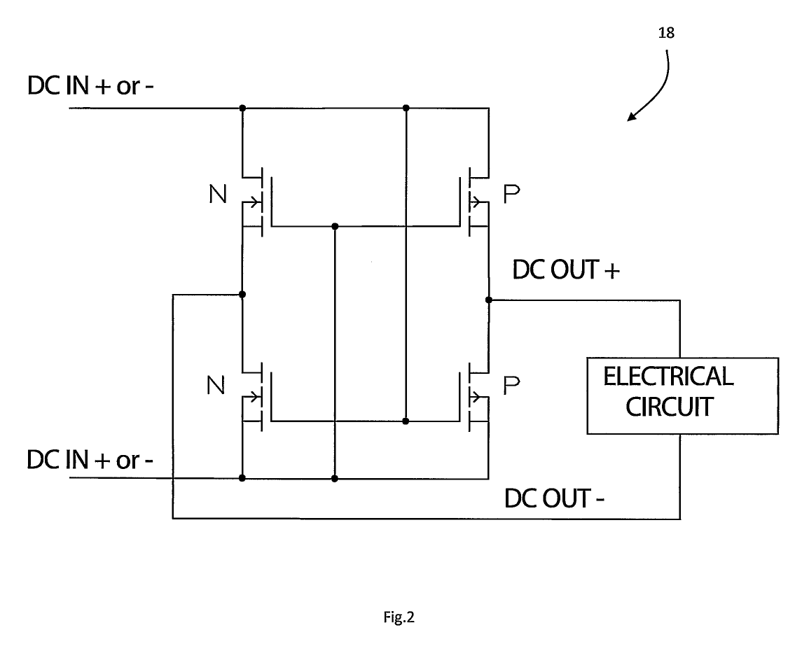

It is desirable that the device powers up correctly irrespective of how the power wires are connected at installation (that is, it is polarity insensitive). As shown in FIG. 2, each LED circuit 4 may comprise a bridge comprising four FETs (two p-type and two n-type) combined to form a full bridge circuit 18. Thus, the device powers up correctly irrespective of how the power wires were connected and a 20-fold improvement in power loss is maintained compared to prior approaches.

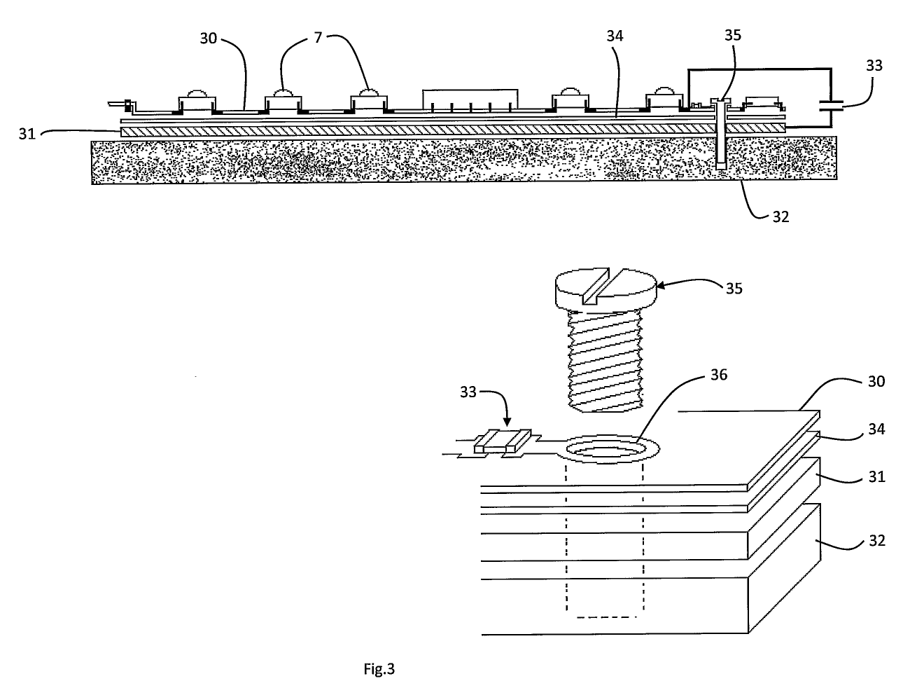

Referring to FIG. 3 the LEDs 7 are on a thin (c100 μm) PCB 30 with a high thermal conductivity, on a metal substrate 31, over a heat sink 32. A capacitor 33 couples the circuit 0V and the metal substrate 31. There is an insulating layer 34 between the conductor 30 and the metal substrate 31. The capacitor is connected between the conductors 30 and the metal substrate 31 by a screw 35 electrically contacting a round track 36 (in turn contacting the capacitor 33) on the board 34 at its top, and contacting the heat sink 32 at its bottom end.

For reasons of cost and physical size, it is desirable that the control circuitry be located on the same PCB as the LEDs. This arrangement has a drawback however, because it means there is only one layer of copper available for the circuitry. For the best circuit performance of a switching power supply, a second electrically conducting layer underneath the circuit and directly connected to 0V (known as a ground plane) is normally present. The metal substrate and heatsink underneath the circuit may become electrically exposed to the environment, and so cannot be connected to the circuit 0V. Additionally, because of the proximity of the metal substrate 32 to the circuitry, externally sourced signals on this can lead to unpredictable circuit behaviour. In order to solve the issue, the capacitor 33 provides DC separation and AC coupling between the circuit 0V and the metal substrate 31 and heatsink 32, ensuring proper operation of the circuit. The capacitor provides a path for conducting unwanted AC signals to 0V thereby ensuring they do not interfere with the circuit's operation.

Furthermore, electronic circuitry that switches at high frequency often produces unwanted electromagnetic emissions. In this invention, should it be required to reduce emissions this may be done by adding an inductive choke to the power and 0V lines on the PCB itself, saving cost and improving the cosmetic appearance of the luminaire.

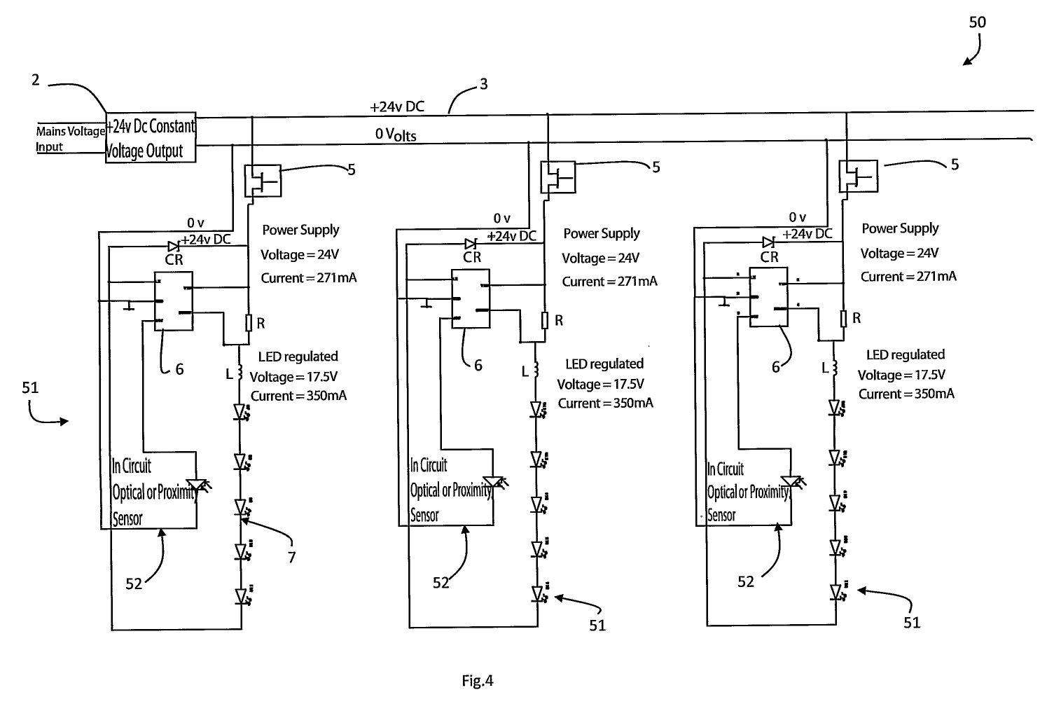

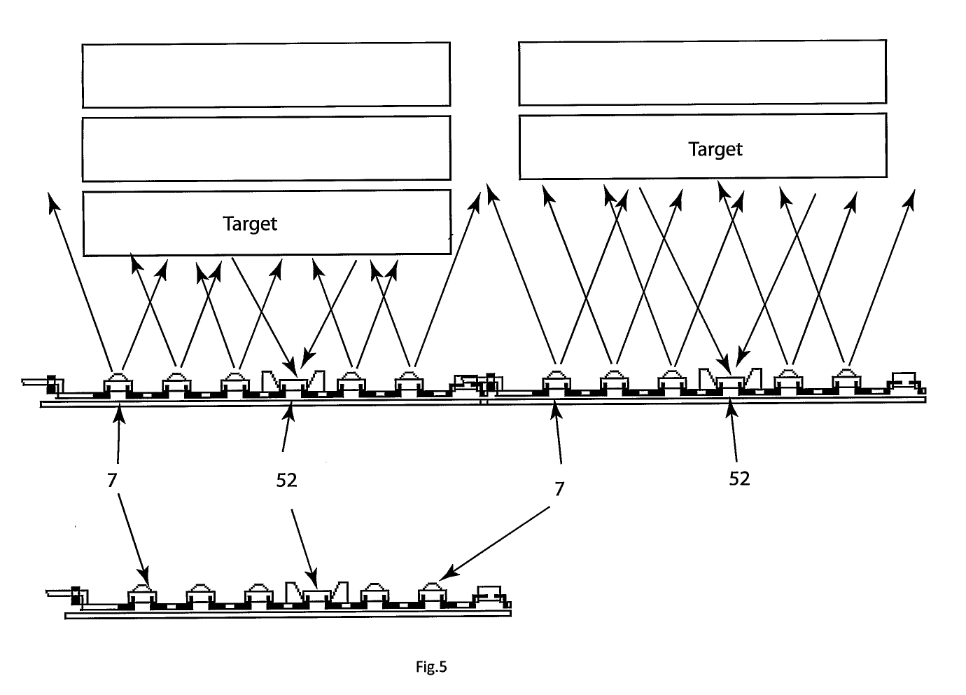

Referring to FIGS. 4 and 5 an alternative drive circuit, 50, is illustrated, and parts similar to those of FIG. 1 are given the same reference numerals. In this embodiment, there is no common dimming control line, instead an object proximity sensor 52 within each individual LED circuit 51 supplies control signals to the voltage and current controller 6. In more detail, the sensor 52 comprises one photodiode 52 per LED chain, mounted such as to measure the amount of light reflected from the illuminated object in front of it. The control circuitry adjusts the light output in accordance with the signal from the photodiode. In this embodiment, automatic proximity sensing control is achieved by mere use of a photodiode, as it utilises the reflectance of the emitted light by the LEDs to provide proximity information.

Alternatively, the sensor could comprise a dedicated proximity sensor comprising an active transmitter/receiver combination. A signal distinct from the luminaire illumination output is transmitted and its reflection read by the receiver in order to infer the proximity of the target object. Examples using such transmitter/receiver technologies include infra red and ultrasonic sensors.

Also, there may be a global illuminated object proximity sensor for the whole drive circuit included in the bank of sensors 10 of the embodiment of FIG. 1

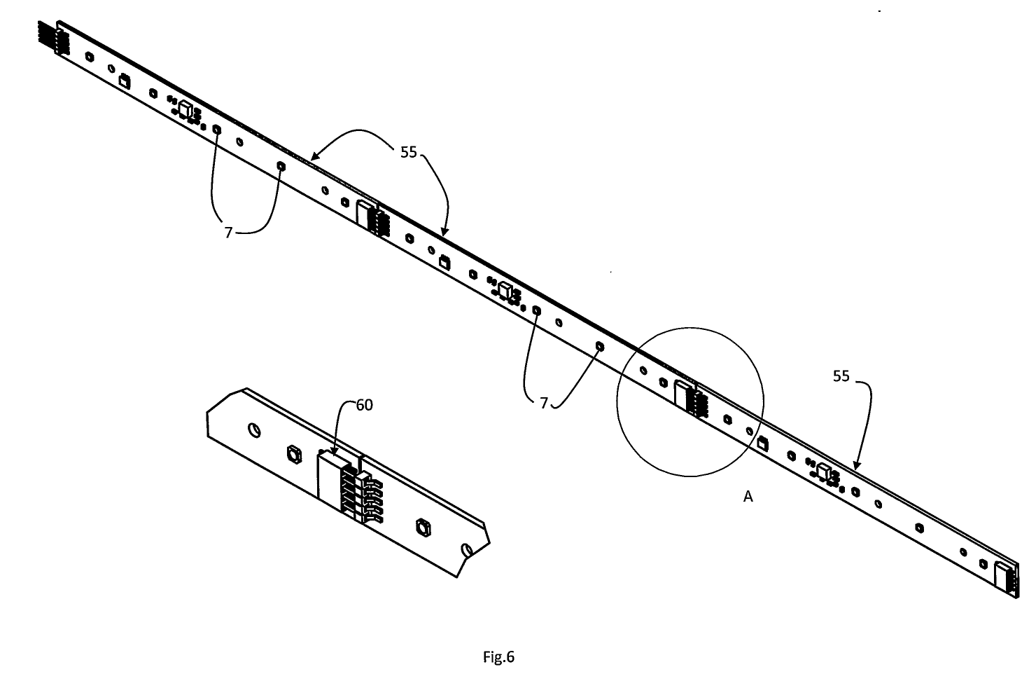

These embodiments allow individual control for each of a number of physically separate locations. For example, if each LED circuit 51 is on a PCB segment 55 in a line of such segments as shown in FIG. 6 there is individual control for each segment 55. Thus if the luminaire is aligned vertically, each segment can be individually controlled for a particular display cabinet shelf.

From an electrical point of view, the LED circuits 51 are in parallel and each is connected to a common power rail 3. These common lines are distributed to the electrical circuits via pins 60 of the connectors shown in FIG. 5.

The proximity sensors 52 are used to sense the distance from the associated LEDs 7 to the illuminated object, and the light intensity is adjusted accordingly. This ensures uniform illumination of displayed products, and optimises electrical efficiency. This enables the target objects to be illuminated evenly even though their distance from the luminaire varies continually as objects are added, removed and re-arranged. This aspect of the invention is most advantageous in a retail application where items on a shelf are being illuminated, leading to uniformity of illumination across products at varying distances from the luminaire and enabling energy savings.

In other embodiments, each LED circuit may include different or additional sensors for individual control of each series of LEDs. For example, the temperature of the PCB could be monitored and the light output reduced if the temperature exceeds a set point. This would ensure the LED lifetime in applications where the ambient temperature can become unusually high. The current regulator automatically lowers LED power consumption in response to excessively high temperature of the LED circuit. For retail display applications, where the ambient temperature can vary depending on the local ambient conditions, a benefit of this is to ensure the rated lifetime of the luminaire is achieved. Benefits are (i) to ensure the desired illumination level is achieved irrespective of changes in background lighting (ii) energy savings, since in the absence of the light sensor, the luminaire would generally be set to fully on.

There may be multiple environmental sensors in each LED circuit, and by controlling the light according to inputs from a number of different sensor types an optimal combination of all the benefits accruing from each sensor can be achieved.

The CRI and colour temperature of a luminaire will vary to some extent with changes in the ambient temperature. If a particular application values constant CRI and/or colour temperature above other parameters such as luminous flux, by sensing the ambient temperature the current in the luminaire can be automatically adjusted to ensure that the desired CRI and/or colour temperature are maintained.

It will be appreciated that an optimum combination of illumination quality (uniformity, CRI and colour temperature), electrical efficiency and luminaire lifetime is achieved by using a power supply to convert mains AC to a fixed low DC voltage and individually controlling current and voltage in each of multiple LED circuits. By simultaneously regulating the voltage across and the current in the LEDs, the LED driving signal ensures that the current in each LED is the same, resulting in tightly controlled luminous flux, excellent uniformity of light output and luminaire lifetime. Any number of LED circuits can be added, and since each LED circuit has its own regulation circuitry, differences in individual LED characteristics become irrelevant.

It will also be appreciated that the desired colour temperature is maintained by the individual current regulation, the luminous flux output is maintained by the current regulation, the efficiency is not affected by using different LEDs, overall performance is not affected by using LEDs with different electrical characteristics.

Failure of a single LED will at worst cause the failure of the chain in which it resides, and the rest of the luminaire will continue to function as before. This means that there will not be a complete luminaire outage in the event of a single LED failure and the lifetime of the remaining functioning LEDs is not compromised.

The following summarises advantageous aspects.
A safe low voltage sent to the luminaire.
Variances in luminaire input voltage regulation are acceptable.
Luminaire can comprise one or more independent LED controller circuits.
The number of LEDs in the luminaire can be extended indefinitely without loss of electrical efficiency.
Failure or degradation of a single LED has local effects only and does not impact the integrity of the rest of the luminaire.
Colour temperature of LEDs is uniform throughout the luminaire due to the current regulation.
Luminous flux output of LEDs is uniform throughout the luminaire due to the current regulation.
Different types of LEDs can be interchanged without making any other alterations.
Low loss reverse polarity protection by use of a FET.
Can be dimmed to a pre-programmed level by simply switching a control line to 0V.
Can be dimmed to an arbitrary level using PWM.
Can achieve improved uniformity of illumination of objects whose proximity to the luminaire varies.

The invention is not limited to the embodiments described but may be varied in construction and detail. The proximity sensor may be of a different type, for example using ultrasonic, optical, infra-red or any other proximity sensing technology.

1-20. (canceled)

21. A luminaire drive circuit comprising:
DC power rails, and
a plurality of LED drive circuits connected across the rails to receive DC power, each LED drive circuit comprising a plurality of LEDs in series and comprising a voltage and current controller for controlling current through the LEDs and voltage across the LEDs which is less than the voltage across the rails; and
wherein a fixed voltage plus the total LED forward voltage is less than a worst case minimum supply voltage.

22. The luminaire drive circuit as claimed in claim 21, wherein each LED drive circuit comprises a FET component in series with a supply rail to provide reverse polarity protection

23. The luminaire drive circuit as claimed in a claim 21, wherein the FET component (5) is of p-type, the drain of the FET is connected to a positive rail input and the gate of the FET is connected to a negative rail input.

24. The luminaire drive circuit as claimed in claim 21, further comprising a bridge for each LED circuit, the bridge comprising four FETs arranged to ensure the circuit powers up irrespective of supply polarity.

25. The luminaire drive circuit as claimed in claim 21, wherein the circuit is on a circuit board over a metal substrate, in turn over a metal heat sink.

26. The luminaire drive circuit as claimed in claim 21, wherein the circuit is on a circuit board over a metal substrate, in turn over a metal heat sink; and wherein there is a capacitor coupling the circuit to the metal substrate.

27. The luminaire drive circuit as claimed in claim 21, wherein the circuit is on a circuit board over a metal substrate, in turn over a metal heat sink; and wherein there is a capacitor coupling the circuit to the metal substrate; and wherein the capacitor has a value in the range of 0.001 uF to 10 uF.

28. The luminaire drive circuit as claimed in claim 21, wherein the circuit is on a circuit board over a metal substrate, in turn over a metal heat sink; and wherein there is a capacitor coupling the circuit to the metal substrate; and wherein the capacitor is connected to the top end of a screw fastener, said fastener extending through an insulating part of the circuit board and to the metal substrate.

29. The luminaire drive circuit as claimed in claim 21, wherein the drive circuit further comprises an environmental sensor means, and each LED circuit voltage and current controller responds to a control signal input from said sensor means.

30. The luminaire drive circuit as claimed in claim 21, wherein the drive circuit further comprises an environmental sensor means, and each LED circuit voltage and current controller responds to a control signal input from said sensor means; and wherein the control input is in a pulse width modulation format.

31. The luminaire drive circuit as claimed in claim 21, wherein the drive circuit further comprises an environmental sensor means, and each LED circuit voltage and current controller responds to a control signal input from said sensor means; and wherein said control signal input is connected to a global control line, and said control line is connected to said environmental sensor means.

32. The luminaire drive circuit as claimed in claim 21, wherein the drive circuit further comprises an environmental sensor means, and each LED circuit voltage and current controller responds to a control signal input from said sensor means; and wherein the environmental sensor means comprises a proximity sensor for sensing proximity of an illuminated object, and at least one voltage and current controller automatically varies LED current and therefore illumination level according to object proximity.

33. The luminaire drive circuit as claimed in claim 21, wherein the drive circuit further comprises an environmental sensor means, and each LED circuit voltage and current controller responds to a control signal input from said sensor means; and wherein the environmental sensor means comprises a temperature sensor, and at least one voltage and current controller automatically lowers LED power consumption in response to excessively high temperature of the drive circuit or an LED circuit.

34. The luminaire drive circuit as claimed in claim 21, wherein the drive circuit further comprises an environmental sensor means, and each LED circuit voltage and current controller responds to a control signal input from said sensor means; and wherein the environmental sensor means comprises an ambient light sensor and at least one voltage and current controller automatically controls the level of illumination according to the ambient light level.

35. The luminaire drive circuit as claimed in claim 21, wherein the drive circuit further comprises an environmental sensor means, and each LED circuit voltage and current controller responds to a control signal input from said sensor means; and wherein the environmental sensor means comprises a proximity sensor, a temperature sensor, and an ambient light sensor, and at least one voltage and current controller comprises means for controlling uniformity of illumination according to combination of illuminated object proximity, temperature, and ambient light.

36. The luminaire drive circuit as claimed in claim 21, wherein the drive circuit further comprises an environmental sensor means, and each LED circuit voltage and current controller responds to a control signal input from said sensor means; and wherein the environmental sensor means comprises a proximity sensor for sensing proximity of an illuminated object, and at least one voltage and current controller automatically varies LED current and therefore illumination level according to object proximity; and wherein the proximity sensor comprises a photodiode mounted to detect the extent of LED-emitted light which is reflected from a proximal illuminated object.

37. The luminaire drive circuit as claimed in claim 21, wherein the drive circuit further comprises an environmental sensor means, and each LED circuit voltage and current controller responds to a control signal input from said sensor means; and wherein there is a dedicated environmental sensor for each LED circuit.

38. The luminaire drive circuit as claimed in claim 21, wherein each LED circuit is on a linear circuit board, and the circuit boards are electrically interconnected by connectors at each end of the board.

39. A luminaire comprising a plurality of light emitting diodes mounted on a circuit and a drive circuit comprising:
DC power rails, and
a plurality of LED drive circuits connected across the rails to receive DC power, each LED drive circuit comprising a plurality of LEDs in series and comprising a voltage and current controller for controlling current through the LEDs and voltage across the LEDs which is less than the voltage across the rails; and
wherein a fixed voltage plus the total LED forward voltage is less than a worst case minimum supply voltage.
